(19) United States
(12) Patent Application Publication
(10) Pub. No.: US 2007/0036048 A1
(43) Pub. Date: Feb. 15, 2007

(54) Optical disk recording and reproducing apparatus

(75) Inventors: Byeong Hee Lee, Suwon-Si (KR); Hyun Woo Lim, Seoul (KR); Sung Bae Hwang, Seoul (KR); Sun Ok Jang, Suwon-Si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/493,812

(22) Filed: Jul. 27, 2006

(30) Foreign Application Priority Data
Aug. 10, 2005 (KR) 2005-73469

(51) Int. Cl. G11B 20/00

(52) U.S. Cl. 369/47.16

(57) ABSTRACT

An optical disk recording and reproducing apparatus including at least two optical disk drives, and a digital converter to encode and decode audio/video (A/V) signals reproduced from the at least two optical disk drives. The digital converter is installed at a middle portion between the at least two optical disk drives, such that the at least two optical disk drives and the digital converter respectively form the shortest communication paths possible.

### CROSS-REFERENCE TO RELATED APPLICATION

This application claims the benefit of Korean Application No. 2005-73469, filed Aug. 10, 2005 in the Korean Intellectual Property Office, the disclosure of which is incorporated herein by reference.

### BACKGROUND OF THE INVENTION

1. Field of the Invention

Aspects of the present invention relate to optical disk technology, and, more particularly, to an optical disk recording and reproducing apparatus whose structure provides a characteristic chip arrangement and a communication interface.

2. Description of the Related Art

Regarding conventional recording media with large storage capacities, with recent increases in amounts of information capable of being stored, such information is often recorded and read out from the recording media by an optical method rather than by an electrical method.

In particular, the conventional electrical method records information in the recording media such that capacitance and resistance of positions to store information are changed. Also, the electrical method reads information from the recording media such that changes of the capacitance and the resistance may be electrically detected. On the other hand, the optical method records information in an optical recording media as light characteristics in positions to store the information, such as, transmittance, reflectance, phase, polarization, etc., are changed. Also, the optical method reads information from the optical recording media as changes of the light characteristics are detected by light.

An optical disk, which is one of type of recording medium, records information by an application of the optical method. On the other hand, the information recorded in the optical disk is read out via the use of a collimated laser beam that is scanned onto the optical disk and via an interpretation of changes of the light characteristics, such as reflectance, phase or polarization of laser beam reflected from a surface of the optical disk, that are detected.

The conventional optical discs include a compact disk (CD) and a digital versatile disk (DVD). The DVD, whose diameter is the same as that of the CD, stores a movie with a quality similar to that of television broadcasting. Since the fall of 1996, DVD players and software for processing a movie recorded thereon have been sold on the market. Generally, DVDs have recording capacities which are 6 to 8 times that of CDs. A light source for the DVD is a semiconductor laser whose wave length is 635-650 nm, which is shorter than that of the wavelength of laser beams normally used with CDs, which is approximately 780 nm. Also, an aperture of an objective lens for DVDs is larger than that of CDs. Therefore, the recording capacity of the DVD is large compared with the CD. On the other hand, video signals are compressed based on the MPEP2 international standard.

As such, recording and/or readout operations of data recorded on an optical disk are performed through an optical disk drive. Data to be stored in an optical disk and data read from an optical disk are processed by dedicated coder-decoder (CODEC) software or a dedicated CODEC chip. When a CODEC chip is used, the advanced technology attachment packet interface (ATAPI) standard is adopted as a communication interface between the optical disk drive and the CODEC chip.

Under the ATAPI standard, a communication cable is limited in length to 45 cm. Namely, when the length of the communication cable is over 45 cm, stability of data transmitted through the communication cable cannot be guaranteed. Therefore, a system including an optical disk drive must be configured such that the length of the communication cable cannot exceed such a lengthwise limitation to allow for the use of the ATAPI standard as a communication interface between the optical disk drive and the CODEC chip.

### SUMMARY OF THE INVENTION

Therefore, it is an aspect of the invention to provide an optical disk recording and reproducing apparatus including at least two optical disk drives, which is capable of improving data communication quality between the at least two optical disk drives, as an arrangement of structure among the at least two optical disk drives and a digital converter is improved.

In accordance with aspects of the invention, the above and/or other aspects may be achieved by the provision of an optical disk recording and reproducing apparatus including at least two optical disk drives, and a digital converter to encode and decode audio/video (A/V) signals reproduced from the at least two optical disk drives. The digital converter is installed at a middle portion between the at least two optical disk drives, such that the at least two optical disk drives and the digital converter respectively form the shortest communication paths possible.

In accordance with aspects of the invention, the digital converter is a codec chip.

In accordance with aspects of the invention, the apparatus further includes a main board on which the digital converter is mounted.

In accordance with aspects of the invention, the main board is installed in the middle portion between the at least two optical disk drives.

In accordance with aspects of the invention, the at least two optical disk drives are adjacent to right and left of the main board, respectively.

In accordance with aspects of the invention, the main board and the at least two optical disk drives comprise communication cable connectors, which are connected to each other via communication cables, respectively, such that the at least two optical disk drives and the digital converter communicate with each other.

In accordance with aspects of the invention, the communication cable connectors and the communication cable are connected to each other based on ATAPI standard.

In accordance with aspects of the invention, one of the at least two optical disk drives is a reproducing-dedicated optical disk drive and another is a recording/reproducing optical disk drive.

In accordance with another aspect of the invention, there is provided an optical disk recording and reproducing apparatus, comprising a plurality of optical disk drives, and a main board on which a digital converter is mounted, in which the digital converter encodes and decodes audio/video (A/V) signals reproduced from the plurality of optical disk drives, wherein each of the optical disk drives are installed to be adjacent to the main board, and the plurality of optical disk drives is symmetrically located with respect to the main board.

In accordance with aspects of the invention, the digital converter is a codec chip.

In accordance with aspects of the invention, the main board and the plurality of optical disk drives have communication cable connectors, which are connected to each other via communication cables, respectively, such that the plurality of optical disk drives and the digital converter communicate with each other.

In accordance with aspects of the invention, the communication cable connectors and the communication cable are connected to each other based on ATAPI standard.

In accordance with aspects of the invention, one of the pluralities of optical disk drives is a reproducing-dedicated optical disk drive and another is a recording/reproducing optical disk drive.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of an optical disk recording and reproducing apparatus according to an embodiment of the present invention; and

FIG. 2 illustrates a top view of an internal structure of an optical disk recording and reproducing apparatus of FIG. 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

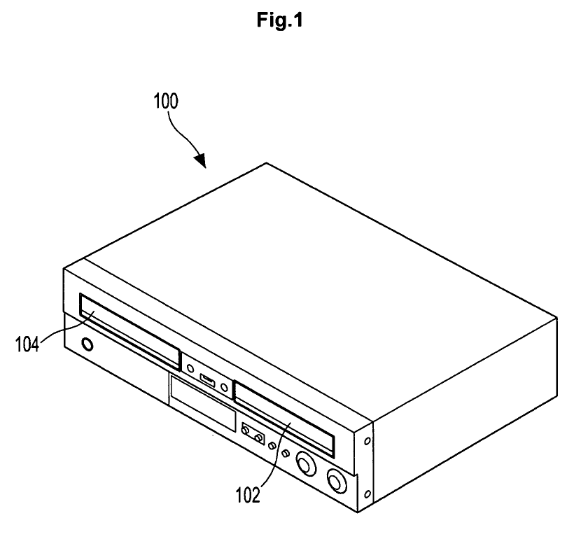

FIG. 1 is a perspective view of an optical disk recording and reproducing apparatus according to an embodiment of the present invention. As shown in the drawing, the optical disk recording and reproducing apparatus 100 includes first and second optical disk drives 102 and 104, which are located to a left and right of the center thereof.

The first optical disk drive 102 is a reproducing dedicated drive. The reproducing dedicated drive may operate an Audio CD, a CD-Recordable (CD-R), a CD-Rewritable (CD-RW), a DVD, a DVD-video, a DVD-Recordable, a DVD-Rewritable, a DVD-RAM, etc, and/or combinations thereof.

The second optical disk drive 104 is a recoding/reproducing drive. The recoding/reproducing drive may operate reproducing optical discs, such as an audio CD, a Video CD (VCD), a DVD, a DVD-Video, and a rewritable/reproducible optical discs, such as a DVD-Recordable (DVD-R), a DVD-Rewritable (DVD-RW), a DVD-RAM, a CD-Recordable, (CD-R), a CD-Rewritable (CD-RW), etc, and/or combinations thereof.

As shown in FIG. 1, the optical disk recording/reproducing apparatus 100 performs copy operations from the first optical disk drive 102, as a source, to a second optical disk drive 104, as a destination (or target). This may be regarded as a similar operation to a disk copy operation. Also, the optical disk recording/reproducing apparatus 100 performs multi-functions, such as a recording operation, a copy operation, and a reproducing operation. Namely, the optical disk recording/reproducing apparatus 100 is operated such that the second optical disk drive 104 performs the multi-functions of broadcasting signals received by a television, etc., while the first optical disk drive 102 reproduces images or music. However, it is understood that the drive 102 could further record data in other aspects of the invention.

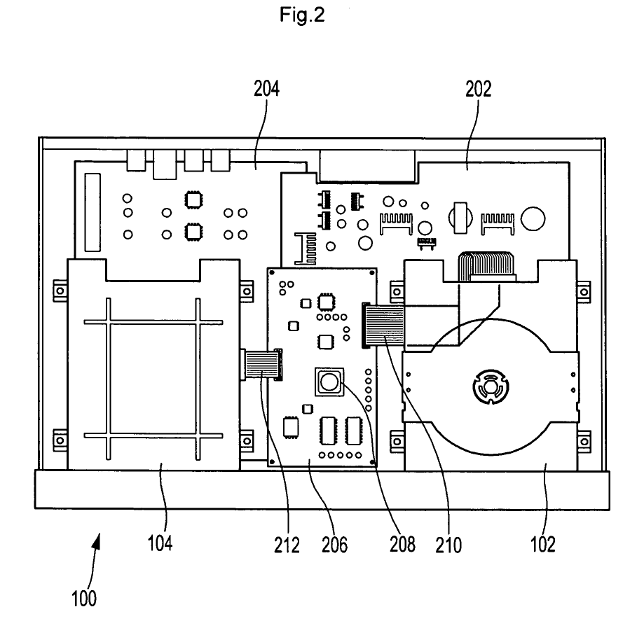

FIG. 2 illustrates a top view of an internal structure of an optical disk recording and reproducing apparatus of FIG. 1. As shown in FIG. 2, the optical disk recording/reproducing apparatus 100 includes a switch mode power supply (SMPS) board 202, a Jack board 204, a main board 206, and first and second optical disk drives 102 and 104.

The SMPS board 202 stably provides power to the optical disk recording/reproducing apparatus 100. The Jack board 204 includes a tuner block to receive broadcasting signals and to perform multiplex transmission, etc., an audio/video switching block to input and output audio/video (A/V) signals, and a front microprocessor block to receive a key input signal and a remote control signal (i.e., an infrared signal) and to control a tuner, etc, and/or combinations thereof. The main board 206 has a CODEC chip 208 mounted thereon, which is used as a digital signal converter. Here, the CODEC chip 208 encodes/decodes audio/video signals based on the MPEG2 format. On the other hand, each of the SMPS board 202 and the main board 206 is electrically connected to the Jack board 204 via additional connectors (not shown in the drawing).

The main board 206, on which the CODEC chip 208 is mounted, is installed in a middle portion between the first optical disk drive 102 and the second optical disk drive 104, such that the main board 206, may be electrically connected to each of the first and second optical disk drives 102 and 106 via a first communication cable 210 and a second communication cable 212, respectively. Here, the first and second communication cables 210 and 212 follow the ATAPI standard.

The optical disk recording/reproducing apparatus 100 performs a recording operation of data, which is inputted from the exterior of the apparatus 100, as follows. Audio/video (A/V) signals, which are inputted from an external device through an input terminal of the Jack board 204, are converted to digital signals and then transmitted to the main board 206. The main board 206 is operated such that the converted digital signals are encoded based on the MPEG2 format in the CODEC chip 208 and then transmitted to a recordable optical disk in the second optical disk drive 104 through the second communication cable 212, thereby recording the digital data in the recordable optical disk.

Also, the first optical disk drive 102 performs a disk copy operation as follows. When audio/video signals in an optical disk of the first optical disk drive are transmitted to the CODEC chip 208 of the main board 206 through the first communication cable 210, the audio/video signals are encoded based on the MPEG2 format in the CODEC chip 208, as discussed above. Then, the encoded signals are transmitted to the second optical disk drive 104 through the second communication cable 212, such that the transmitted signals may be recorded in a recordable optical disk of the second optical disk drive 104.

When the first and second optical disk drives 102 and 104 reproduce optical discs, audio/video signals are transmitted to the main board 206 through the first and second communication cables 210 and 212, respectively. Afterwards, the transmitted signals are encoded based on the MPEG2 format in the CODEC chip 208, such that the encoded signals may be transmitted to display devices, such as, a monitor or a television, etc. While described in terms of optical disk drives, it is understood that the apparatus 100 can further include non-optical media drives in addition to or instead of one or both of the optical disk drives 102, 104.

As shown in FIG. 2, the optical disk recording/reproducing apparatus 100 including at least two optical disk drives 102 and 104 is configured such that the main board 206, on which the CODEC chip 208 to encode and decode audio/video (A/V) signals, is installed in the middle portion of the first and second optical disk drives 102 and 104.

As such, since the main board 206 is installed in the middle portion between the first and the second optical disk drives 102 and 104, the first and second communication cables 210 and 212 may have their respective lengths significantly reduced between the first and second optical disk drives 102 and 104 and the CODEC chip 208.

When the main board 206 is located to the right of the first optical disk drive 102, the length of the first communication cable 210, which connects the first optical disk drive 102 with the main board 206, may be kept relatively short. However, the second communication cable 212, which connects the second optical disk drive 104 with the main board 206, must be arranged to either cross over the first optical disk drive 102 or to go around the first optical disk drive 102. Therefore, the length of the second communication cable 212 is inevitably increased.

On the other hand, when the main board 206 is located to the left of the second optical disk driver 104, the length of the second communication cable 212, which connects the second optical disk drive 104 with the main 206, may be kept relatively short. However, the first communication cable 210, which connects the first optical disk drive 102 with the main board 206, must be arranged to either cross over the second optical disk drive 104 or to go around the second optical disk drive 104. Therefore, the length of the first communication cable 210 is inevitably increased.

In order to resolve such problems, as the main board 206 is installed in the middle between the first and second optical disk drives 102 and 104, the first and second communication cables 210 and 212 among the optical disk drives 102 and 104 and the CODEC chip 208 may have their respective lengths significantly reduced.

When the main board 206 cannot be installed in the middle between the first and second optical disk drives 102 and 104, the first and second optical disk drives 102 and 104 are installed to be adjacent to the main board 206 or the CODEC chip 208, such that they may be symmetrically installed with respect to the main board 206. Therefore, the respective communication paths between the first and second optical disk drives 102 and 104 from the main board 206 may be kept relatively short. While described as being in the middle, it is understood that the CODEC chip 208 need only be between the drives 102, 104 so long as the location of the drives 102, 104 does not require either cable 210, 212 to be longer than 45 cm and/or to exceed the ATAPI standard.

As such, the communication paths between the first and second optical disk drives 102 and 104 from the main board 206 may be significantly reduced. Namely, as the lengths of the first and second communication cable 210 and 212 may be significantly reduced, distortion and quality deterioration of signals, which are transmitted through the first and second communication cables 210 and 212, may also be reduced. In particular, when the ATAPI standard, which is used as communication interface between the optical disk drives and the CODEC chip, is adopted, the lengths of the communication cables must be properly adjusted. Namely, when the communication cable length is relatively long, stability of data transmission cannot be guaranteed. However, according to the embodiment of the present invention, the communication cable lengths may be significantly reduced though relocation of the main board 206. Therefore, although the ATAPI standard is adopted as communication interface, data is stably transmitted.

Also, as the lengths of the first and second communication cables 210 and 212, which connect the main board 206 with the first and second optical disk drives 102 and 104, are significantly reduced, the internal wiring of the optical disk recording/reproducing apparatus 100 is relatively more clearly arranged. Therefore, the assembly procedure of the optical disk recording/reproducing apparatus may be relatively easily performed. While described in terms of optical media, aspects of the invention can be used where one or both media are non-optical media.

In addition, when the main board 206 is installed in the middle portion between the first and second optical disk drives 102 and 104, since the first and second optical disk drives 102 and 104 are symmetrically arranged with respect to the main board 206, the optical disk recording/reproducing apparatus 100, according to an aspect of the present invention, is configured for greater stability.

Furthermore, as the main board 206 is installed in the middle between the first and second optical disk drives 102 and 104, the optical disk recording/reproducing apparatus 100 according to an aspect of the present invention has a weight thereof balanced more accurately than conventional apparatuses such that transportation may be stably performed.

As is described above, since the main board, on which a CODEC chip or a main board is mounted, is installed in the middle between at least two optical disk drives, the main board has the CODEC chip mounted thereon, such that the lengths of the communication cables among the main board and the at least two optical disk drives are significantly reduced. Therefore, deterioration of communication quality may be minimized and wiring of the apparatus may be relatively simple. Also, the assembly procedure of the optical disk recording/reproducing apparatus may be relatively easily performed. In addition, the appearance and weight of the optical disk recording/reproducing apparatus may be balanced.

While not required in all aspects, the drives 102, 104 can be vertically stacked as opposed to horizontally adjacent to each other. Further, it is understood that the CODEC can encode/decode other data types instead of or in addition to MPEG data.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An optical disk recording and reproducing apparatus, comprising:
at least two optical disk drives; and
a digital converter to encode and decode audio/video (A/V) signals reproduced from the at least two optical disk drives, wherein the digital converter is installed between at least two of the optical disk drives, such that the at least two optical disk drives and the digital converter respectively form the shortest communication paths possible.

2. The apparatus as set forth in claim 1, wherein the digital converter comprises a codec chip.

3. The apparatus as set forth in claim 1, further comprising a main board on which the digital converter is mounted, wherein the main board is installed in a middle portion between the at least two optical disk drives.

4. The apparatus as set forth in claim 3, wherein the at least two optical disk drives are adjacent to right and left regions of the main board, respectively.

5. The apparatus as set forth in claim 3, wherein the main board and the at least two optical disk drives comprise communication cable connectors, which are connected to each other via communication cables, respectively, such that the at least two optical disk drives and the digital converter communicate with each other.

6. The apparatus as set forth in claim 5, wherein the communication cable connectors and the communication cables are connected to each other based on the ATAPI standard.

7. The apparatus as set forth in claim 1, wherein one of the at least two optical disk drives comprises a reproducing-dedicated optical disk drive and the other comprises a recording/reproducing optical disk drive.

8. An optical disk recording and reproducing apparatus, comprising:
a plurality of optical disk drives; and
a main board on which a digital converter is mounted, in which the digital converter encodes and decodes audio/video (A/V) signals reproduced from the plurality of optical disk drives, wherein each of the optical disk drives are installed to be adjacent to the main board, and the plurality of optical disk drives are symmetrically located with respect to the main board.

9. The apparatus as set forth in claim 8, wherein the digital converter comprises a codec chip.

10. The apparatus as set forth in claim 8, further comprising communication cable connectors, which are connected to each other via communication cables, respectively, such that the plurality of optical disk drives and the digital converter communicate with each other via the communication cables and connectors.

11. The apparatus as set forth in claim 10, wherein the communication cable connectors and the communication cables are connected to each other based on the ATAPI standard.

12. The apparatus as set forth in claim 1, wherein one of the plurality of optical disk drives comprises a reproducing-dedicated optical disk drive and the other comprises a recording/reproducing optical disk drive.

13. An optical disk recording and reproducing apparatus, comprising:
first and second optical disk drives; and
a digital converter to encode and decode audio/video (A/V) signals reproduced from the first and second optical disk drives, wherein the digital converter is installed at a position relative to the first and second optical disk drives, such that communication paths between the first and second optical disk drives and the digital converter are each minimized.

14. The apparatus as set forth in claim 13, wherein the digital converter comprises a codec chip.

15. The apparatus as set forth in claim 13, further comprising a main board on which the digital converter is mounted, wherein the main board is installed between the first and second optical disk drives.

16. The apparatus as set forth in claim 15, wherein the first and second optical disk drives are adjacent to right and left regions of the main board, respectively.

17. The apparatus as set forth in claim 15, wherein the main board and the first and second optical disk drives comprise communication cable connectors, which are connected to each other via communication cables, respectively, are compliant with the ATAPI standard, such that the first and second optical disk drives and the digital converter communicate with each other.

18. The apparatus as set forth in claim 13, wherein the first optical disk drive comprises a reproducing optical disk drive and the second optical disk drive comprises a recording/reproducing optical disk drive.

19. An optical disk recording and reproducing apparatus, comprising:
a plurality of optical disk drives; and
a digital converter encoding and decoding audio/video (A/V) signals reproduced from and/or recorded to the optical disk drives, wherein each of the optical disk drives are adjacent to the digital converter and substantially symmetrical with respect to each other about the digital converter.

20. The apparatus according to claim 19, wherein a first one of the optical disk drives is connected to the digital converter using a first ATAPI compliant connection cable, a second one of the optical disk drives is connected to the digital converter using a second ATAPI compliant connection cable, and lengths of each of the first and second cables are less than or equal to 45 cm.
